(19) United States
(12) Patent Application Publication
(10) Pub. No.: US 2025/0170861 A1
(43) Pub. Date: May 29, 2025

(54) Optimized Tire Architecture

(71) Applicant: COMPAGNIE GENERALE DES ETABLISSEMENTS MICHELIN, Clermont-Ferrand (FR)

(72) Inventors: William LICENSE, Clermont-Ferrand Cedex 9 (FR); Olivier REIX, Clermont-Ferrand Cedex 9 (FR); Eva JOANNET, Clermont-Ferrand Cedex 9 (FR); Lodoic DE KERRET, Clermont-Ferrand Cedex 9 (FR)

(21) Appl. No.: 18/841,988

(22) PCT Filed: Feb. 20, 2023
(86) PCT No.: PCT/EP2023/054203

§ 371 Date: Aug. 27, 2024

(30) Foreign Application Priority Data
Feb. 28, 2022 (FR) FR2201725

(51) Int. Cl. B60C 19/12; B60C 9/00

(52) U.S. Cl. CPC B60C 19/12; B60C 9/0007; B60C 2200/06

(57) ABSTRACT

Radial tire for heavy vehicles, having a load index greater than 1050 kg, with a crown reinforcement (3) having at least two layers of metal transverse reinforcers (321, 322), forming, with the circumferential direction, oriented angles of opposite signs at least equal to 10° and at most equal to 70°, having a breaking strength at least equal to 80 daN. The crown reinforcement having at least one radially outermost anti-puncture layer, constituted of chainmail of metal rings of a ferrous alloy. The chainmail being coated in at least one polymeric material, in that the mass of an anti-puncture layer is at most equal to 70% of the mass of the other crown layers.

The present invention relates to a radial tire, intended to be fitted to a load transport vehicle of the van, light truck, heavy-duty or construction plant type and certain agricultural vehicles. It relates more particularly to the crown reinforcement of such a tire.

Radial tires intended to be fitted to such vehicles are designated within the meaning of the European Tyre and Rim Technical Organisation or ERTRO standard. The invention relates to tires of which the load indices are greater than 110, namely of which the nominal load is greater than 1050 kg and which are intended to be mounted on a rim with a diameter at least equal to 16 inches.

A radial tire for a heavy vehicle of construction plant type, within the meaning of the European Tyre and Rim Technical Organisation or ETRTO standard, is intended to be mounted on a rim with a diameter at least equal to 25 inches. Although not limited to this type of application, the invention is described particularly for a radial tire of large size, which is intended to be mounted on a dumper, in particular on vehicles for transporting materials extracted from quarries or surface mines, by way of a rim with a diameter at least equal to 35 inches, possibly as much as 57 inches, or even 63 inches, and bearing nominal loads greater than 20 000 kg.

A radial tire for a heavy-duty vehicle, within the meaning of the European Tyre and Rim Technical Organisation or ETRTO standard, is intended to be mounted on a rim with a diameter at least equal to 17.5 inches and at most equal to 24 inches for a load index greater than 126, i.e. their nominal load is greater than 1650 kg.

The radial tires for vans that are covered by the invention have load indices greater than 110, i.e. with a nominal load greater than 1050 kg, and are intended to be mounted on a rim with a diameter at least equal to 16 inches and less than 20 inches.

The radial tires for agricultural vehicles that are covered by the invention have load indices greater than 132, i.e. of which the nominal is load greater than 2000 kg, and are intended to be mounted on a rim with a diameter at least equal to 18 inches.

The expression “radial tires for vehicles covered by the invention” denotes all tires, vans, heavy-duty, construction plant and agricultural vehicles as described above.

Since a tire has a geometry exhibiting symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively. The circumferential direction is tangential to the circumference of the tire.

In the following text, the expressions “radially on the inside” and “radially on the outside” mean “closer to” and “further away from the axis of rotation of the tire”, respectively. “Axially on the inside” and “axially on the outside” mean “closer to” and “further away from the equatorial plane of the tire”, respectively, the equatorial plane of the tire being the plane passing through the middle of the tread surface and perpendicular to the axis of rotation.

Generally, the median circumferential plane, called equator plane or equatorial plane, perpendicular to the axis of rotation of the tire and passing through the center of the tread, cuts the tire into two half-tori that are substantially symmetrical with respect to said plane, give or take laying variations relating to the part of the tire that is radially on the inside of the tread.

Generally, a tire comprises a tread intended to come into contact with the ground via a tread surface, the two axial ends of which are connected via two sidewalls to two beads that provide the mechanical connection between the tire and the rim on which it is intended to be mounted.

A radial tire also comprises a reinforcement made up of a crown reinforcement radially on the inside of the tread and of a carcass reinforcement radially on the inside of the crown reinforcement.

The carcass reinforcement of a radial tire for the vehicles covered by the invention usually comprises at least one carcass layer comprising reinforcers, or reinforcing elements, which are generally metal but sometimes textile, in particular for van tires, which are coated in a polymeric material of the elastomer or elastomeric type that is obtained by blending and is known as a coating compound. A carcass layer comprises a main part that connects the two beads together and is generally wound, in each bead, from the inside of the tire to the outside around a usually metal circumferential reinforcing element known as a bead wire so as to form a turn-up. The reinforcers of a carcass layer are substantially mutually parallel and form an angle of between 80° and 100° with the circumferential direction.

The crown reinforcement of a radial tire for the vehicles covered by the invention comprises a superposition of circumferentially extending crown layers, radially on the outside of the carcass reinforcement. Each crown layer is made up of generally metal reinforcers that are mutually parallel and coated in a polymeric material of the elastomer or coating compound type.

The crown reinforcement of a radial tire for the vehicles covered by the invention comprises at least two layers of metal transverse reinforcers, the metal reinforcers of said layers of transverse reinforcers forming, with the circumferential direction at the equator plane, oriented angles at least equal to 10° and at most equal to 70°, at least two angles of two layers of transverse reinforcers being of opposite signs, the metal reinforcers of at least one of said layers of transverse reinforcers having a breaking strength at least equal to 80 daN. The purpose of these crown layers is to absorb some of the inflation forces and the transverse forces, and as such they are often referred to as working layers. Their laying angles at the equator plane are oriented angles usually between equal to 15° and 45°. For a radial tire for the vehicles covered by the invention, the nominal inflation pressure is greater than 4 bar or even 5 bar for vans and 7 to 9 bar for heavy-duty tires in order to bear the load. This pressure entails a minimum breaking force of the metal reinforcers of the layers of transverse reinforcers. For agricultural tires, the pressures are lower in off-road use but, given the load, the metal reinforcers used also have a breaking strength at least equal to 80 daN.

For a radial tire for the vehicles covered by the invention, among the crown layers, a distinction is usually made between the one or more protective layers, which make up the protective reinforcement and are radially outermost, and the working layers, which make up the working reinforcement and are radially comprised between the protective reinforcement and the carcass reinforcement. The protective layers generally absorb only very little transverse force, whether their laying angle with the circumferential direction is much closer to 90° than the laying angle of the working layers, or moreover the reinforcers of the working layers are stiffer than the reinforcers of the one or more protective layers.

The protective reinforcement, comprising at least one protective layer, essentially protects the working layers from mechanical or physicochemical attack, likely to spread through the tread radially toward the inside of the tire.

The protective reinforcement often comprises a protective layer for the tires for vans, for heavy-duty vehicles, for the agricultural vehicles covered by the invention and often two protective layers for construction plant vehicles. The protective layers are then radially superposed, formed of extensible metal reinforcers that are mutually parallel in each layer and crossed from one layer to the next, forming angles at least equal to 10° with the circumferential direction.

The working reinforcement, comprising at least two working layers, has the function of belting the tire and conferring stiffness and road holding thereon. It absorbs both mechanical inflation stresses, which are generated by the tire inflation pressure and transmitted by the carcass reinforcement, and mechanical stresses caused by running, which are generated as the tire runs over the ground and are transmitted by the tread. It is also intended to withstand oxidation and impacts and puncturing, by virtue of its intrinsic design and that of the protective reinforcement responsible for protecting the other crown layers from external attack, tears or other punctures.

The two working layers, which are radially superposed, are therefore formed of metal reinforcers that are often non-extensible or less extensible than the metal reinforcers of the one or more protective layers. The metal reinforcers of the working layers are mutually parallel in each layer and crossed from one layer to the next, forming angles at most equal to 60°, and preferably at least equal to 10° and at most equal to 45°, with the circumferential direction. For satisfactory absorption of the radial and transverse forces, designers seek to maximize the breaking force of the reinforcing elements of the working layers.

In order to reduce the mechanical inflation stresses that are transmitted to the working reinforcement, it is known practice to dispose, in the crown reinforcement, a hoop reinforcement made up of one or more hooping layers. The hoop reinforcement, the function of which is to at least partially absorb the mechanical inflation stresses, improves the endurance of the crown reinforcement by stiffening the crown reinforcement. The hoop reinforcement may be positioned radially on the inside of the working reinforcement, between the two working layers of the working reinforcement, or radially on the outside of the working reinforcement.

In applications of the construction plant type, the hoop reinforcement can comprise two hooping layers, which are radially superposed, formed of metal reinforcers that are mutually parallel in each layer and crossed from one layer to the next, forming angles at most equal to 10° but at least equal to 5° with the circumferential direction. In this case, the reinforcing elements of the hooping layers are laid in layers and stretch from one axial edge to the other of said hooping layers in less than one revolution of the tire on its axis of rotation.

In applications of the heavy-duty type, the hoop reinforcement generally comprises a hooping layer, formed of metal reinforcers that are mutually parallel, forming angles at most equal to 10° with the circumferential direction.

A hooping layer can be produced by the circumferential winding of a hooping wire or a continuous hooping strip, forming angles at most equal to 5° with the circumferential direction.

With respect to the metal reinforcers, a metal reinforcer is mechanically

characterized by a curve representing the tensile force (in N) applied to the metal reinforcer as a function of its relative elongation (in %), referred to as the force-elongation curve. Mechanical tensile characteristics of the metal reinforcer, such as the structural elongation As (as a %), the total elongation at break At (as a %), the force at break Fm (maximum load in N) and the breaking strength Rm (in MPa), are derived from this force-elongation curve, these characteristics being measured in accordance with standard ASTM D 2969-04 of 2014.

The total elongation at break At of the metal reinforcer is, by definition, the sum of its structural, elastic and plastic elongations (At=As+Ae+Ap) and particularly at break, when each of the elongations is non-zero. The structural elongation As results from the relative positioning of the metal threads making up the metal reinforcer under a low tensile force. The elastic elongation Ae results from the actual elasticity of the metal of the metal threads making up the metal reinforcer, taken individually, the behavior of the metal following Hooke's law. The plastic elongation Ap results from the plasticity, i.e. the irreversible deformation beyond the yield point, of the metal of these metal threads taken individually. These various elongations and the respective meanings thereof, which are well known to those skilled in the art, are described, for example, in the documents U.S. Pat. No. 5,843,583, WO2005/014925 and WO2007/090603.

Also defined, at each point on the force-elongation curve of a metal reinforcer, is a tensile modulus expressed in GPa, which represents the gradient of the straight line tangential to the stress-elongation curve at this point. In particular, the tensile modulus of the elastic linear part of the stress-elongation curve is referred to as the tensile elastic modulus or Young's modulus.

Among the metal reinforcers, a distinction is usually made between extensible metal reinforcers, such as those used in the protective layers, and inextensible or non-extensible metal reinforcers, such as those used in the working layers.

An extensible metal reinforcer, in its non-rubberized state, is characterized by a structural elongation As at least equal to 1% and a total elongation at break At at least equal to 3%. In addition, an extensible metal reinforcer has a tensile elastic modulus or Young's modulus at most equal to 180 GPa, and usually between 40 GPa and 150 GPa.

In its rubberized state extracted from a polymer matrix, namely a tire, an extensible metal reinforcer is characterized by a structural elongation As at least equal to 0.5% and a total elongation at break At at least equal to 3%, the polymer matrix preventing some of the movements of the threads responsible for structural elongation. In addition, an extensible metal reinforcer has, in its rubberized state extracted from a polymer matrix, a tensile elastic modulus or Young's modulus at most equal to 150 GPa, and usually between 40 GPa and 120 GPa.

A non-extensible metal reinforcer is characterized by a total elongation At, under a tensile force equal to 10% of the force at break Fm, at most equal to 0.2%. Moreover, a non-extensible metal reinforcer has a tensile elastic modulus usually between 150 GPa and 200 GPa.

The vehicles covered by the invention, in addition to bearing the load and therefore having a certain pressure, are used on terrain comprising stones or other more or less sharp objects present on the ground on which they run, ground undergoing work, tracks, mining roads on which the dumpers travel, forest roads for the agricultural tires in question. The crown of a tire is frequently subject to cuts that are likely to pass radially through it toward the inside and, depending on the size of the object, puncture the crown reinforcement and carcass reinforcement assembly, creating a loss of pressure and leading to the failure of the tire. The use of extensible metal reinforcers in the protective layers is known to improve the puncture resistance of tires by allowing improved adaptation of said protective layer to the shape of the obstacle; however, given the cost of tires of large size and the frequency of these incidents, it is still important to improve performance in terms of puncture resistance.

The inventors set themselves the objective, for a radial tire for heavy vehicles of the van, heavy-duty, construction plant or agricultural type, having a load index greater than 110 or a nominal load greater than 1050 kg, of reducing the risk of puncturing of the tire following attacks on the tread when running over sharp stones while at the same time controlling the mass of the crown reinforcement.

This objective has been achieved, according to the invention, by a radial tire for heavy vehicles of the van, heavy-duty, construction plant or agricultural type, having a load index greater than 110 or nominal load greater than 1050 kg, comprising:
a crown reinforcement, radially on the outside of a carcass reinforcement and radially on the inside of a tread,
said tread being connected, via two sidewalls, to two beads on either side of a median circumferential plane, called equator plane, perpendicular to the axis of rotation of the tire and passing through the center of the tread,
the carcass reinforcement extending between the two beads,
the crown reinforcement comprising at least two layers of transverse metal reinforcers, each having a surface density of metal,
the metal reinforcers of said layers of transverse reinforcers forming, with the circumferential direction at the equator plane, oriented angles at least equal to 10° and at most equal to 70°, at least two angles of two layers of transverse reinforcers being of opposite signs, the metal reinforcers of at least one of said layers of transverse reinforcers having a breaking strength at least equal to 80daN,
the crown reinforcement comprising at least one radially outermost anti-puncture layer, having a surface density of metal,
the at least one anti-puncture layer being chainmail constituted by an assembly of metal rings made of ferrous alloy and having an outer diameter (d), said chainmail being coated in at least one polymeric material,.
the surface density of metal of the at least one anti-puncture layer being at most equal to 70% of the sum of the surface densities of metal of the layers of transverse reinforcers.

For tires of which the crown layers are textile, and for which the mass is a major concern, the invention is not an advantageous technical solution. For tires of which the load indices are low, such as passenger vehicle tires, their uses are limited to asphalted roads with a nominal pressure and load index making them suitable for absorbing the usual impacts. The invention is of little interest to the user for this use.

The invention consists of a radial tire having a load index greater than 110 and of which the crown reinforcement comprises at least two layers of metal transverse reinforcers. These two layers of transverse reinforcers are usually called working layers when their reinforcers are inelastic. Their function is to absorb the forces, in particular transverse forces, in cornering and some, if not all, of the pressure forces of the tire. In this configuration, the metallic reinforcers of at least one of said layers of transverse reinforcers has a breaking strength at least equal to 80 daN.

If the crown reinforcement comprises a hoop reinforcement, the metal reinforcers of which form, with the circumferential axis of the tire, an angle at most equal to 10°, the reinforcers of the transverse layers absorb only some of the pressure and centrifugation forces.

The reinforcing elements of the layers of transverse reinforcers may be elastic or inelastic. They therefore have a tensile elastic modulus or Young's modulus at least equal to 40 GPa. Specifically, a tire comprising only elastic reinforcers, provided that the elasticities of the reinforcers are balanced with respect to their various functions in the tire, has shown its advantage in certain performance qualities, particularly in terms of crown impact resistance. These tires according to the prior art comprise at least one radially outermost protective layer. A protective layer differs from the layers of transverse reinforcers in the sense that either its elastic modulus is significantly less than the elastic modulus of the layers of transverse reinforcers, or its structural elongation As is significantly greater than the structural elongation As of the layers of transverse reinforcers. In these two cases, it only absorbs very little transverse force. The inventors have, surprisingly, observed that replacing the one or more protective layers with chainmail of metal rings coated with at least one polymeric material, which has an equivalent mass or even a reduced mass compared with one or more protective layers, improved the performance in terms of crown impact resistance, especially with indenting bodies with a beveled end that are more capable of puncturing the tire, despite the fact that the steel of the rings of the chainmail has a much lower breaking strength than the high-strength steels of the protective layers and that the anti-puncture layer has, on account of its construction, a breaking strength an order of magnitude lower than the protective layers.

In order to measure the surface density of the layers, a solution well known to those skilled in the art is to sample all or part of the layer of metal reinforcers on a tire. The sample will preferably be rectangular in shape, with the width of the layer in the tire and with a length close to said width. After measuring the surface of said sample, the rubber compounds of the sample are removed by a mechanical-chemical process known to those skilled in the art and the mass of metal of the sample is weighed, thus allowing the calculation of the surface density of the crown layer in question.

A preferred method of manufacture is to deposit the chainmail in a regular manner, with or without tension, on a first layer of rubber compound, or coating material, and to calender this with a second layer of rubber compound. The rings are thus held in relative position with respect to one another in a circumferentially regular arrangement. This phase is particularly important, the chainmail having a very high deformability. The measurement of the elongation at break according to standard ASTM E8 of such an anti-puncture layer, under tension in the longitudinal direction, is at least equal to 120% and, preferably, at least equal to 140% in versions in which the chainmail is laid untaut, namely with a small pitch. This value is to be compared with elongations at most equal to 10% for the protective layers of existing products. This feature seems to be more able to explain the performance since the anti-puncture layers tested have a markedly lower breaking strength than said usual protective layers. Moreover, this high deformability is one of the major advantages of the chainmail, since, being very flexible, it offers no resistance to the bending and compression deformations caused by the crushing of the tire under its load or by running. As a result, an anti-puncture layer can, without any problem, be positioned at a certain distance from the neutral axis of the crown reinforcement. The flexibility of the anti-puncture layers enables them to withstand, without damage, the tension-compression cycles at a distance from the neutral axis of the crown reinforcement where layers of transverse metal reinforcers, hooping layers or protective layers would rapidly break in fatigue.

Moreover, the impact on the rolling resistance of the tire of such a layer is of the order of magnitude of the contribution of its volume of rubber compound. Its use is therefore not detrimental to this performance quality as a replacement for one or two protective layers.

Preferably, the at least one anti-puncture layer is chainmail of which the assembly is referred to as 4 rings in 1 ring according to the expression of those skilled in the art. This means that, with the exception of the rings situated at the ends, in particular the axial ends, of the anti-puncture layer, 4 rings pass through any ring. More precisely, chainmail is constituted by an assembly of rings in which each ring, with the exception of the rings positioned at the transverse ends of the anti-puncture layer, is interlaced with four other rings, so as to constitute a mesh of respectively longitudinal and transverse rows of rings. There are assemblies of 6 rings in 1 ring or of 8 rings in 2 rings, however these arrangements are not optimal in terms of the thicknesses of each anti-puncture layer.

Since the chainmail creates a mesh of respectively longitudinal and transverse rows of rings, it is possible to measure a longitudinal pitch and a transverse pitch, the pitch being the distance between two consecutive rings on one and the same longitudinal, respectively transverse, row. A preferred solution is for the longitudinal pitch, respectively the transverse pitch, of the at least one anti-puncture layer to be between 0.5 and 0.7 times the outer diameter of the rings. Thus laid, the anti-puncture layer has a greater effectiveness than chainmail laid taut. It seems that, surprisingly, in order to effectively withstand puncturing, it is not appropriate to immediately provide a certain stiffness with respect to the indenting body but to deform first and then to provide stiffness. The longitudinal or transverse laying pitch is measured on a fabric sampled from the tire. When the rings of the chainmail are disposed in a regular manner, the rings are disposed in transverse and longitudinal lines. When removing the rubber compounds radially on the outside of the anti-puncture layer, for each ring, apart from the rings situated on the edge of the anti-puncture layer, there are longitudinally, respectively transversely, adjacent rings of which the center is situated on the same axis longitudinally, respectively transversely, give or take positioning errors namely of plus or minus 25% of the outer diameter of the rings. The longitudinal, respectively transverse, pitch is the longitudinal, respectively transverse, distance between the two centers of these two longitudinally, respectively transversely, adjacent rings. This measurement practice is known to those skilled in the art for taking measurements on the various layers of metal reinforcers perpendicular to the cords.

The radial thicknesses of the rubber compound and of the anti-puncture layer are measured on a meridian section through the tire, obtained by cutting the tire on two meridian planes. By way of example, a tire meridian section has a thickness in the circumferential direction of around 60 mm at the tread. The measurement is taken with the distance between the two beads being kept identical to that of the tire mounted on its rim and lightly inflated. The measurements will be taken on a plurality of meridian sections distributed all around the tire and will be processed statistically for the evaluation of a mean value over the circumference of the tire. The measurements are taken from edge to edge of metal reinforcers. Thus, the radial thickness of the rubber compound is taken from the radially outermost edge of a cord of the layer of metal reinforcers that is radially adjacent to the anti-puncture layer to the radially innermost edge of the rings of the anti-puncture layer. The radial thickness of the anti-puncture layer is taken between the two edges, the radially innermost edge and the radially outermost edge, of the rings of the anti-puncture layer.

An advantageous solution is that the rings of the at least one anti-puncture layer are a steel of which the carbon content is less than 0.2% as a percentage by weight. This considerably improves the possibility of welding the two ends of the rings together in order to obtain chainmail according to the invention.

Similarly, to make it easier to weld the ends of each ring together in order to have rings that are closed on themselves, an advantageous solution is for the rings of the at least one anti-puncture layer to be made of a steel of which the chromium content is greater than 10.5% as a percentage by weight. The coating compounds have to adhere to the chainmail because, otherwise, under the transverse forces, a crack in the width of the chainmail would be created rapidly leading to separation from a part of the tread and from the rest of the tire. The rings of the chainmail are therefore chemically treated in order to allow the rubber compound to adhere to the rings of the chainmail, and this is a process known to those skilled in the art.

Experience shows that, for one and the same mass of metal, it is more advantageous to have a single anti-puncture layer with a smaller pitch than two anti-puncture crown layers with a larger pitch. In order to save mass, it is therefore more advantageous for the crown reinforcement to comprise a single anti-puncture layer.

A preferred solution is for the anti-puncture layer to be separated from the closest crown layer of metal reinforcers by a radial thickness of rubber compound that is at least equal, at the equator plane, to 0.5 times, and preferably at least once, the radial thickness of the anti-puncture layer. Experience has shown that the decoupling of the anti-puncture layer and the closest crown layer of metal reinforcers had a very beneficial effect on the resistance to impacts with a beveled indenting body. This position is entirely acceptable for an anti-puncture layer given its flexibility in compression and in tension. A protective layer made up of cords and rubber compounds would break under compression, thus being away from the neutral axis of the crown reinforcement. The closest crown layer of metal reinforcers may be a layer of transverse reinforcers or a hooping layer, as the case may be.

The features of the invention are illustrated by the schematic FIGS. 1 to 4, which are not drawn to scale, with reference to a tire of construction plant type:

FIG. 1: meridian section through a crown of a tire according to the invention comprising two layers of transverse reinforcers, two hooping layers and an anti-puncture layer decoupled from the other crown layers.

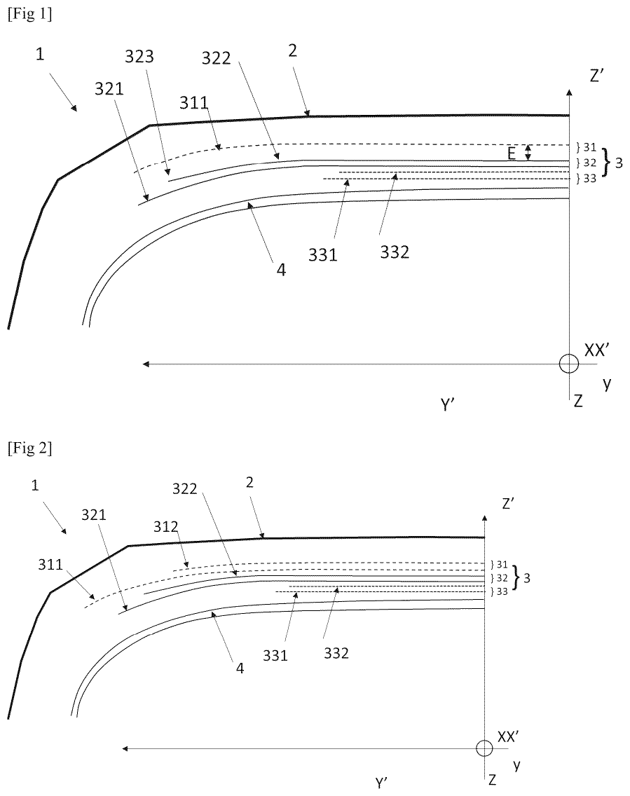

FIG. 2: meridian section through a crown of a tire according to the invention comprising two layers of transverse reinforcers, two hooping layers and two protective layers.

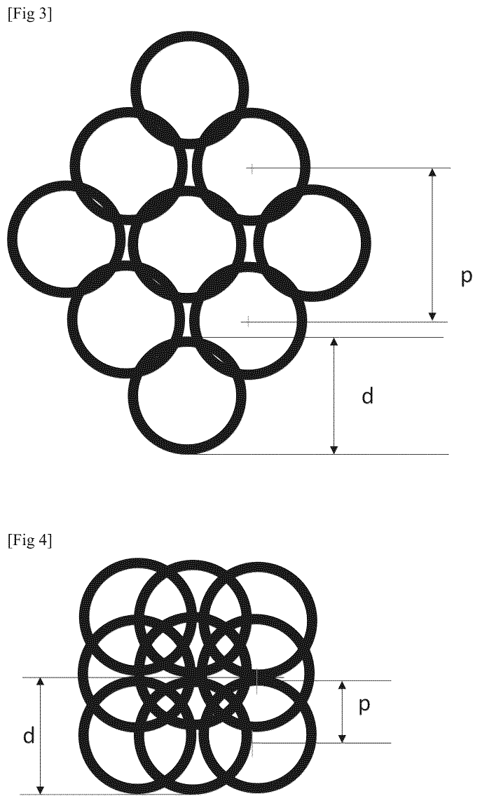

FIG. 3: a depiction of a pattern of chainmail of which the assembly is 4 rings in 1 ring with a maximum laying pitch.

FIG. 4: a depiction of a pattern of chainmail of which the assembly is 4 rings in 1 ring with a minimum laying pitch.

The figures do not show all of the possibilities offered by the invention, such as a version of the invention comprising two anti-puncture layers or no hooping layers. There are numerous possible variants for positioning the various layers comprised in the invention that are not shown.

FIG. 1 shows a meridian section through a tire 1 for a heavy vehicle of

construction plant type according to the invention comprising a crown reinforcement 3 radially on the inside of a tread 2 and radially on the outside of a carcass reinforcement 4. The crown reinforcement 3 comprises layers of transverse reinforcers, more particularly working layers (321, 322), comprising inextensible metal reinforcers coated in an elastomeric material that are mutually parallel and form an angle of between 10° and 45° with a circumferential direction XX′ tangential to the circumference of the tire, the metal reinforcers of the two working layers 321 and 322 being crossed from one layer to the next. The crown reinforcement also comprises two hooping layers (331, 332) of which the extensible metal reinforcers coated in an elastomeric material that are mutually parallel form an angle at most equal to 8° with the circumferential direction XX′. The radially outermost layer 311 is an anti-puncture layer constituted of 4 rings in 1 ring chainmail, i.e., except for the rings on the axial ends of the chainmail, 4 rings pass through 1 ring. The anti-puncture layer is separated by a radial thickness (E) of rubber compound from the closest working layer.

FIG. 2 shows a meridian section through a tire 1 for a heavy vehicle of construction plant type according to the prior art comprising a crown reinforcement 3 radially on the inside of a tread 2 and radially on the outside of a carcass reinforcement 4. The crown reinforcement 3 comprises layers of transverse reinforcers, more particularly working layers (321, 322), comprising inextensible metal reinforcers coated in an elastomeric material that are mutually parallel and form an angle of between 10° and 45° with a circumferential direction XX′ tangential to the circumference of the tire, the metal reinforcers of the two working layers 321 and 322 being crossed from one layer to the next. The crown reinforcement also comprises two hooping layers (331, 332) of which the extensible metal reinforcers coated in an elastomeric material that are mutually parallel form an angle at most equal to 5° with the circumferential direction XX′. The crown reinforcement also comprises two protective layers 311 and 312 comprising extensible metal reinforcers coated in an elastomeric material that are mutually parallel and form an angle of between 10° and 45°.

FIG. 3 is a depiction of a pattern of chainmail of which the assembly is 4 rings in 1 ring with a maximum laying pitch p and an outer ring diameter d. The chainmail thus positioned and coated with an elastomeric coating material, has the lowest elongation at break.

FIG. 4 is a depiction of a pattern of chainmail of which the assembly is 4 rings in 1 ring with a minimum laying pitch p and an outer ring diameter d. The anti-puncture layer with such a pitch has the highest elongation at break compared with solutions with a greater pitch. The layer formed by the chainmail and the rubber compound has to, before breaking, be deformed so as to tauten the chainmail so that the rigidity acted upon is that of the metal rings and no longer of the rubber compounds.

The invention was tested on heavy-duty tires of size 15.5R20 of which the nominal load is 7800 kg. The tires according to the invention were compared with reference tires of the same size for each of the tests. The rubber compounds of, respectively, the tires according to the invention and the reference tires, and the corresponding tread patterns are identical. The carcass reinforcements, the hooping layers and the working layers are also identical between the tires according to the invention and the reference tires. The reinforcers of the hooping layers, working layers and carcass reinforcement are all metal reinforcers. The reinforcers of the working layers, or of the layers of inelastic transverse reinforcers, have a breaking strength of 287 daN; they form, with the circumferential direction, a mean angle equal to 24° that is opposite from one layer to the other. The reference tires have two protective layers comprising reinforcers made of high-strength steel made up of 18.23 elastic cords, namely cords made up of 18 steel threads of 23 hundredths of a millimeter, with a laying pitch of 3 mm. Their structural elongation As is equal, in their rubberized state extracted from a polymer matrix, to 0.6%, their total elongation at break At is equal to 3.9%, their Young's modulus is equal to 75 GPa, and their breaking strength is 154 daN. They form an angle of 24° with the circumferential direction and are crossed from one layer to the next.

The anti-puncture layers tested are layers constituted of chainmail of which the assembly is 4 rings in 1 ring made of 302 stainless steel, each ring consisting of an individual thread 0.7 mm in diameter, formed into a circle, its two ends being welded to one another. The rings have an outer diameter (d) equal to 7 mm. 302 stainless steel comprises at most 0.05% carbon and 16 to 18% chromium as a percentage by weight.

The rings are chemically treated to allow adhesion of the coating rubber compound to the rings. The sum of the surface densities of metal of the working layers is 8.8 kg/m² and the maximum surface density tested for an anti-puncture layer is equal to 4.27 kg/m², i.e. less than 50% of the sum of the surface densities of metal of the working layers.

The rings of the chainmails tested here are manufactured from steel threads of circular section, but the invention also works with threads of square or rectangular section, or even any section.

The invention has been tested in 4 forms, including 3 versions with a single anti-puncture layer to replace the two protective layers:
A version A, in which the anti-puncture layer is not decoupled from the crown reinforcement and the rings are laid at a pitch of 7 mm for a total mass of the anti-puncture layer that is equal to 50% of the mass of the protective layers of the reference tires. The elongation at break of this puncture layer is equal to 148.5%.
A version B, in which the anti-puncture layer is not decoupled from the crown reinforcement and the rings are laid at a pitch of 3.9 mm for a total mass of the anti-puncture layer that is equal to 100% of the mass of the protective layers of the reference tires. The elongation at break of this puncture layer is equal to 228.5%.
A version C, in which the anti-puncture layer is decoupled from the crown reinforcement by a rubber compound layer with a radial thickness of 5 mm and the rings are laid at a pitch of 7 mm for a total mass of the anti-puncture layer that is equal to 50% of the mass of the protective layers of the reference tires. The anti-puncture layer has a radial thickness equal to 2.9 mm. The elongation at break of each puncture layer is equal to 148.5%.

The final version D comprises two anti-puncture layers that are not decoupled from the crown reinforcement, which are radially adjacent, of which the rings are laid at a pitch of 7 mm for a total mass of the anti-puncture layers that is equal to 100% of the mass of the protective layers of the reference tires. The elongation at break of each puncture layer is equal to 148.5%.

The performance of the crown in terms of puncture resistance is measured by two quasi-static tests carried out using two indenting bodies with different ends representing two different uses depending on the type of obstacles encountered, namely non-cutting puncturing and cutting puncturing:
a cylindrical indenting body 300 mm long, with a circular base with a diameter of 76.6 mm, the end of which, intended to come into contact with the tire, is spherical.
a cylindrical indenting body 300 mm long, with a circular base with a diameter of 76.6 mm, the end of which, intended to come into contact with the tire, is beveled on symmetrical planes relative to the axis of the cylinder, the tip of the bevel having an angle of 46°.

The quasi-static tests push the indenting body, at a speed of 50 mm/min, into the tire inflated to the recommended pressure, namely 7 bar. The indenting body is pushed in at the center of the tread. The measured result of the test is the penetration distance necessary to break the crown reinforcement. The results are given in base 100, where 100 is the result for the reference tire. A result of more than 100 indicates better performance than that of the reference tire.

As regards the balance of the performance respectively in terms of mass (200% of

the performance in terms of mass means a division by 2 of the mass of the anti-puncture layer with respect to the mass of the protective layers of the reference tires), resistance to penetration of the indenting body with a spherical end, and resistance to penetration of the indenting body with a beveled end compared to the control, the tests yielded:
variant A of the invention: 200. 95, 108
variant B of the invention: 100, 137, 113
variant C of the invention: 200, 104, 123
variant D of the invention: 100, 135, 118

Each of the letters tested offers an obvious benefit:
The mass for variant A of the invention, with a mass saving of 100% with respect to the control for variations that are not very significant for the puncture resistance for the two types of indenting bodies. For a construction plant tire, this can represent about ten kilograms of metal.
Improvements in resistance to penetration of both types of indenting bodies for variants B and D of the invention.
the mass and the resistance to penetration of the beveled indenting body for variant C of the invention.

On the basis of such results, by choosing a suitable laying pitch for the chainmail between the extremes tested, it is entirely conceivable to find a solution with a significant metal mass saving of between 120 and 200% and reductions in penetration of the indenting bodies of between 20 and 30%.

It is notable that the results are given for chainmails of which the rings are made of a common steel offering low breaking strength. The breaking strength of an anti-puncture layer is of the order of 10% of the strength of a protective layer of the reference tire. This increases the advantage of the invention insofar as this type of steel allows use of nearly 100% recycled steel, when the high-strength steels of the control only allow a recycled steel content close to 70% to be used. Conversely, by increasing the quality of the steel of the rings of the chainmail, the performance in terms of puncture resistance will be increased. This demonstrates all the advantages of the invention.

1. A radial tire for heavy vehicles of the van, heavy-duty, construction plant or agricultural type, having a load index greater than 110 or nominal load greater than 1050 kg, comprising:
a crown reinforcement, radially on the outside of a carcass reinforcement and radially on the inside of a tread,
said tread being connected, via two sidewalls, to two beads on either side of a median circumferential plane, called equator plane, perpendicular to the axis of rotation of the tire and passing through the center of the tread,
the carcass reinforcement extending between the two beads,
the crown reinforcement comprising at least two layers of transverse metal reinforcers, each having a surface density of metal,
the metal reinforcers of said layers of transverse reinforcers forming, with the circumferential direction at the equator plane, oriented angles at least equal to 10° and at most equal to 70°, at least two angles of two layers of transverse reinforcers being of opposite signs, the metal reinforcers of at least one of said layers of transverse reinforcers having a breaking strength at least equal to 80 daN,
the crown reinforcement comprising at least one radially outermost anti-puncture layer, having a surface density of metal,
wherein the at least one anti-puncture layer is chainmail constituted by an assembly of metal rings made of ferrous alloy and having an outer diameter (d), said chainmail being coated in at least one polymeric material, and
wherein the surface density of metal of the at least one anti-puncture layer is at most equal to 70% of the sum of the surface densities of metal of the layers of transverse reinforcers.

2. The tire as claimed in claim 1, in which the at least one anti-puncture layer is chainmail of which the assembly is referred to as 4 rings in 1 ring.

3. The tire as claimed in claim 1, in which the longitudinal, respectively transverse, pitch (p) of the at least one anti-puncture layer is between 0.5 and 0.7 times the outer diameter (d) of the rings.

4. The tire as claimed in claim 1, in which the rings of the at least one anti-puncture layer are made of a steel of which the carbon content is less than 0.2% as a percentage by weight.

5. The tire as claimed in claim 1, in which the rings of the at least one anti-puncture layer are made of a steel of which the chromium content is greater than 10.5% as a percentage by weight.

6. The tire as claimed in claim 1, in which the crown reinforcement comprises a single anti-puncture layer.

7. The tire as claimed in claim 6, in which the anti-puncture layer is separated from the closest crown layer of metal reinforcers by a radial thickness (E) of rubber compound that is at least equal, at the equator plane, to 0.5 times the radial thickness of the anti-puncture layer.

8. The tire as claimed in claim 1, in which the elongation at break under longitudinal tension of the anti-puncture layer, measured according to standard ASTM E8, is at least equal to 120%.

9. The tire as claimed in claim 6, in which the anti-puncture layer is separated from the closest crown layer of metal reinforcers by a radial thickness (E) of rubber compound that is at least equal, at the equator plane, to at least once the radial thickness of the anti-puncture layer.

10. The tire as claimed in claim 1, in which the elongation at break under longitudinal tension of the anti-puncture layer, measured according to standard ASTM E8, is at least equal to 140%.
